(19) United States
(12) Patent Application Publication
(10) Pub. No.: US 2017/0066172 A1
(43) Pub. Date: Mar. 9, 2017

(54) INJECTION MOLDING SYSTEM

(71) Applicant: FANUC Corporation, Yamanashi (JP)

(72) Inventors: Yasumasa NAGANO, Yamanashi (JP); Wataru SHIRAISHI, Yamanashi (JP)

(21) Appl. No.: 15/255,182

(22) Filed: Sep. 2, 2016

(30) Foreign Application Priority Data
Sep. 4, 2015 (JP) 2015-175176

(51) Int. Cl. B29C 45/80; B29C 45/17

(52) U.S. Cl. CPC B29C 45/80; B29C 45/1774; B29C 2945/76083; B29C 2945/76505; B29C 2945/7618; B29C 2945/76695

(57) ABSTRACT

In an injection molding system, an amount of deformation of an elastic member is calculated from image data of the elastic member causing a nozzle to generate a nozzle touch force and a nozzle touch force of the nozzle is calculated by converting the amount of deformation. Accordingly, it becomes possible to detect abnormal conditions such as resin leakage and mold deformation and exercise correct control of the nozzle touch force.

### RELATED APPLICATIONS

The present application claims priority to Japanese Patent Application Number 2015-175176, filed Sep. 4, 2015, the disclosure of which is hereby incorporated by reference herein in its entirety.

### BACKGROUND OF THE INVENTION

1. Field of the Invention

The present invention relates to an injection molding system, and in particular, relates to an injection molding system that moves forward an injection unit by a power unit such as a motor in an injection molding machine to generate a predetermined nozzle touch force.

2. Description of the Related Art

The injection molding machine includes a clamping unit and an injection unit. In a normal injection molding operation excluding when a resin is ejected, a nozzle of the injection unit abuts on a fixed side mold and a state in which a predetermined nozzle touch force is generated on the mold is maintained. If a continuous molding operation is performed while allowing the nozzle to be in contact with the mold, heat at the tip of the nozzle is lost to the mold and thus, to prevent such a heat loss, an operation called sprue break to separate the nozzle from the mold is performed after a measurement process is completed. The sprue break also has an effect that a sprue is cut between the nozzle and the mold by the backward movement of the nozzle and the mold is opened so that when a molded product is taken out, the molded product is easily extracted from the mold. When a sprue break operation is performed, it is necessary to move forward the nozzle again in the next molding cycle.

An elastic member such as a spring is provided in a nozzle touch mechanism unit that generates a nozzle touch force and a desired nozzle touch force can be generated by controlling the elongation of the elastic member. The following literatures are known as literatures concerning the nozzle touch mechanism unit that generates a nozzle touch force.

In the technology disclosed by JP 2000-351133 A, an elastic member is installed in such a way that an elastic deformation is generated in a nozzle touch process in which a nozzle comes into contact with a mold. A position detection unit for detecting the amount of elastic deformation of the elastic member is provided in a ball screw shaft and a target nozzle touch force is converted into the amount of elastic deformation in advance and set so that the target nozzle touch force is obtained in the nozzle touch process.

In the technology disclosed by JP 05-200784 A, a nozzle touch force is maintained by detecting driving of a servo motor in a position of an injection unit where a nozzle touch force is generated and positioning the servo motor in the position.

In the technology disclosed by JP 2013-56516 A, a nozzle touch force is controlled by an elastic member in an injection device and that a nozzle has touched a fixed side mold is detected in a position where a nozzle touch occurs by setting a proximity switch to a position that reacts when a spring as the elastic member begins to contract.

Also, the following literatures are known as literatures concerning measurements of movement of a clamping unit or deformation of a mold using an image.

JP 2013-126722 A discloses a technology in which a marker to measure the amount of elongation of a tie-bar based on images is provided on the tie-bar in an injection molding machine including the tie-bar elongated in accordance with a clamping force acting on a fixed mold and a movable mold and the marker is imaged to measure the position of the tie-bar.

JP 2010-145231 A discloses a technology in which the amount of displacement of a mark to be measured is calculated from positional information of the mark to be measured provided on a mold of an injection molding machine at different times to correct the amount of displacement of the mark to be measured.

In the technology disclosed by JP 2000-351133 A and JP 05-200784 A, the nozzle touch position is controlled by positioning a servo motor through a position sensor of the servo motor based on the amount of elastic deformation of the elastic member. Thus, the occurrence of abnormal conditions during molding such as resin leakage and deformation of a mold may not be detectable.

In the technology disclosed by JP 2013-56516 A, the proximity switch is installed in a position where the elastic member begins to contract and the proximity switch is incorporated into the nozzle touch mechanism unit and thus, correct detection may not be possible due to the influence of mechanical vibration or backlash. This also applies to the technology disclosed by JP 05-200784 A and the servo motor is positioned by a position sensor of the servo motor and thus, correct detection may not be possible due to the influence of mechanical vibration or backlash.

The technology disclosed by JP 2013-126722 A and JP 2010-145231 A discloses only measurements of elongation of a tie-bar of a clamping unit and deformation of a mold and using images and detection and adjustments of a nozzle touch force are neither described nor suggested.

### SUMMARY OF THE INVENTION

An object of the present invention is to provide an injection molding system capable of correctly controlling a nozzle touch force by detecting the nozzle touch force and detecting abnormal conditions such as resin leakage and mold deformation.

An injection molding system according to the present invention including a mold, a nozzle capable of coming into contact with the mold, and an elastic member causing the nozzle to come into contact with the mold and having an injection unit causing the nozzle to generate a nozzle touch force by deforming the elastic member includes an elastic member shooting unit for shooting the elastic member, a deformation amount calculation unit for calculating an amount of deformation of the elastic member from image data of the elastic member shot by the elastic member shooting unit, and a nozzle touch force conversion unit for converting data of the amount of deformation calculated by the deformation amount calculation unit into the nozzle touch force based on a correlation between the amount of deformation of the elastic member and the nozzle touch force determined in advance.

The injection molding system may further include a nozzle touch force control unit capable of controlling by setting a predetermined nozzle touch force.

Accordingly, the nozzle touch force can appropriately be controlled.

The injection molding system may further include an elastic member shooting position moving unit for moving a shooting position of the elastic member shooting unit.

Accordingly, the elastic member can be shot and measured in a wide range by making the shooting position of the elastic member shooting unit movable.

The injection molding system may include an injection unit shooting unit for shooting the injection unit and an injection unit position calculation unit for calculating a position of the injection unit based on image data of the injection unit shot by the injection unit shooting unit.

Accordingly, it becomes possible to detect abnormal conditions such as resin leakage and mold deformation and exercise correct control of the nozzle touch force by shooting the injection unit using the injection unit shooting unit.

The injection molding system may further include an injection unit reference position storing unit for storing the position of the injection unit calculated by the injection unit position calculation unit in a normal nozzle touch as an injection unit reference position, wherein when the deformation amount calculation unit calculates a predetermined amount of deformation of the elastic member and a difference between the position of the injection unit calculated by the injection unit position calculation unit and the injection unit reference position exceeds the predetermined amount, a warning is issued.

Accordingly, by issuing a warning when, based the injection unit reference position as a reference and the position of the injection unit calculated by the position calculation unit, a difference therebetween exceeds the predetermined amount, the operator can easily be notified of the occurrence of abnormal conditions.

The injection molding system may further include an injection unit shooting position moving unit for moving a shooting position of the injection unit shooting unit.

Accordingly, the injection unit can be shot and measured in a wide range by making the shooting position of the injection unit shooting unit movable.

The position of the injection unit shooting unit may be calculated based on position coordinates of the injection unit shooting position moving unit.

Accordingly, by calculating the position of the injection unit shooting unit based on a mounting position of the injection unit shooting position moving unit and a transfer position of the injection unit shooting unit, the position of the injection unit shooting unit can be calculated based on position coordinates of the injection unit shooting position moving unit.

The injection unit shooting unit may serve also as the elastic member shooting unit.

Accordingly, both of the position of the injection unit and the position or amount of deformation of the elastic member can be measured by one unit of the shooting unit.

The injection molding system may further include a display unit capable of displaying the nozzle touch force converted by the nozzle touch force conversion unit, the position of the injection unit calculated by the injection unit position calculation unit, and the injection unit reference position.

Accordingly, the operator can be notified of the position of the injection unit and the nozzle touch force by the nozzle touch force, the position of the injection unit, and the injection unit reference position being displayed by the display unit.

The injection unit shooting position moving unit may be a robot.

The injection unit shooting unit may be arranged near a molded product extracting unit for extracting a molded product.

According to the present invention, an injection molding system capable of correctly controlling a nozzle touch force by detecting the nozzle touch force and detecting abnormal conditions such as resin leakage and mold deformation can be provided.

### BRIEF DESCRIPTION OF THE DRAWINGS

The above object and other objects of the present invention will be apparent from the description below with reference to appended drawings. Among these drawings:

FIG. 1 is a diagram showing an injection molding system according to an embodiment of the present invention;

FIG. 2 is a diagram showing an example of shooting image data of an elastic member;

FIG. 3A is a diagram showing an example of shooting image data of an injection device;

FIG. 3B is a diagram showing an example of shooting image data of the injection device;

FIG. 4 is a diagram showing an example in which a reference position, a location of measurement, and a nozzle touch force are displayed in a display unit; and

FIG. 5 is a diagram showing an example in which the occurrence of abnormal conditions is displayed in the display unit.

### DETAILED DESCRIPTION OF THE PREFERRED EMBODIMENTS

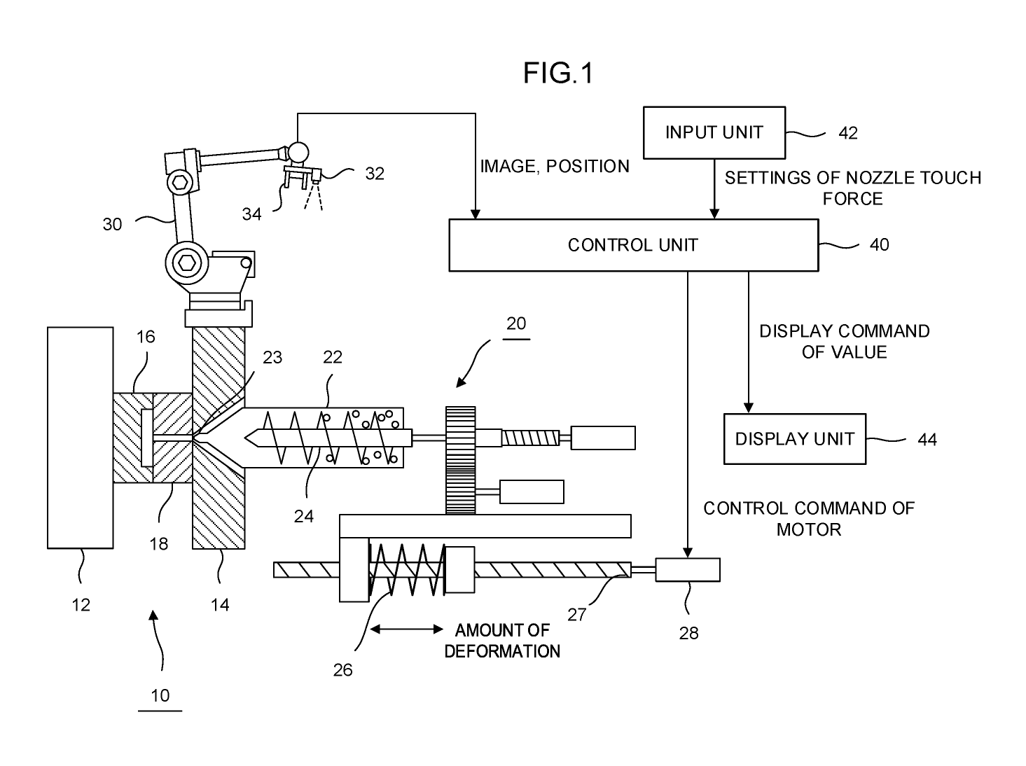

Hereinafter, the embodiment of the present invention will be described based on the drawings. FIG. 1 is a diagram showing an injection molding system according to the present embodiment. Reference numeral 10 is an injection molding machine and a movable platen 12 and a fixed platen 14 are provided in the injection molding machine 10. A movable side mold 16 is provided in the movable platen 12 and a fixed side mold 18 is provided in the fixed platen 14.

An injection cylinder 22, a nozzle 23 provided in a tip portion of the injection cylinder 22, and a screw 24 provided inside the injection cylinder 22 to stir and transfer resin are provided in an injection device 20. In addition, the amount of deformation of an elastic member 26 is changed by a ball screw 27 being rotated by driving of a motor 28. The position of the injection cylinder 22 is thereby changed and the relation of nozzle touch between the injection cylinder 22 and the fixed side mold 18 and a nozzle touch force when the nozzle touches are changed. The motor 28 that generates power for forward and backward movement of the nozzle 23, the ball screw 27 that transfers power from the motor 28, the elastic member 26 that generates a nozzle touch force of the nozzle 23, and a pressure receiving plate (not shown) provided on both ends of the elastic member 26 constitute a nozzle touch mechanism unit.

A control unit 40 calculates the amount of deformation and the position of the elastic member 26, calculates the position of the injection device 20, converts a nozzle touch force between the injection cylinder 22 and the fixed side mold 18, compares the converted nozzle touch force and the set nozzle touch force, controls the injection device 20, the injection cylinder 22 and the like, and stores various setting values. The control unit 40 issues a motor control command to the motor and issues, as will be described below, a display command of various values to a display unit 44. A nozzle touch force set by an input unit 42 is input into the control unit 40.

An articulated robot 30 is provided on the fixed platen 14. A publicly known articulated robot can be used as the articulated robot 30 and motion of a high degree of flexibility can be made by freely rotating several joint portions provided in the articulated robot 30 up and down, left and right. A video camera 32 as an imaging unit and a hand 34 for extracting molded products are provided close to each other in a tip portion of the articulated robot 30. As will be described below, the video camera 32 images the amount of deformation of the elastic member 26 and the positions of the injection device 20 and the injection cylinder 22. Then, the video camera 32 transmits captured images, the amount of deformation of the elastic member 26, and the positions of the injection device 20 and the injection cylinder 22 to the control unit 40.

The nozzle touch mechanism unit moves the injection device 20 forward and backward with respect to the fixed platen 14 by rotating the ball screw 27 through rotation-driving of the motor 28 to allow the nozzle 23 to touch the fixed platen 14.

The display unit 44 displays calculated values, processing results by the control unit 40, and input content into the input unit 42 after a display command from the control unit 40 is received.

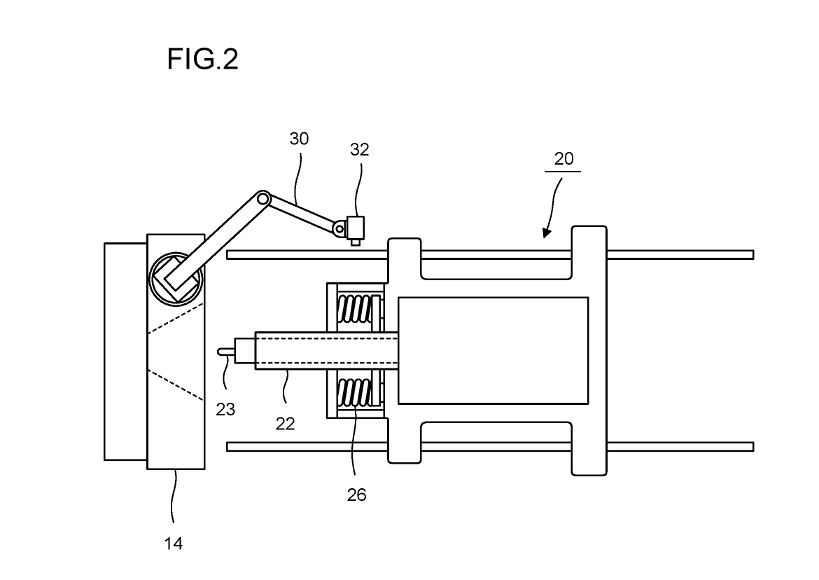

FIG. 2 shows an example of shooting image data of the elastic member 26 by the video camera 32. The video camera 32 is mounted on the tip portion of the articulated robot 30 and so the posture can easily be changed by the motion of joints. Thus, even if the position of the elastic member 26 changes depending on the type of the injection device 20 or the screw 24, the video camera 32 can easily be moved to the coordinate position or shooting angle to be shot so that shooting can easily be performed by approaching the portion to be shot. As a concrete position, as shown in FIG. 2, shooting is performed by moving the video camera 32 so as to be immediately above the elastic member 26.

When determining the amount of deformation of the elastic member 26, a marker or the like is attached in each predetermined period of the elastic member 26 and the distance between these markers can be calculated based on image data. As another method, two components sandwiching the elastic member 26 such as a pressure receiving plate (not shown) and the distance between the two components is calculated based on the shot image data. The position of the articulated robot 30 on the side of the fixed platen 14 on which the video camera 32 is mounted is fixed and thus, the position and the amount of elongation of the elastic member 26 can be detected by moving the video camera 32 so as to be immediately above the elastic member 26.

As still another method, the nozzle touch force is changed while a force sensor such as a load cell is sandwiched between the fixed side mold 18 and the nozzle 23 in advance. As this point, the amount of deformation of the elastic member 26 or two components sandwiching the elastic member 26 are shot by the video camera 32 and the relationship between the amount of deformation of the elastic member 26 and the nozzle touch force is determined as a conversion coefficient and stored. By using the conversion coefficient by, for example, multiplying the amount of deformation of the elastic member 26 by the conversion coefficient, a nozzle touch force can be determined by measuring the amount of deformation of the elastic member 26.

When the nozzle touch force is controlled, the control is exercised by setting a predetermined nozzle touch force and comparing the predetermined nozzle touch force with a calculated nozzle touch force. When a difference of the calculated nozzle touch force from the setting value falls to a predetermined value or less, the nozzle touch mechanism unit is stopped by issuing a control command that stops forward movement of the nozzle 23. Accordingly, a desired nozzle touch force can be obtained. Thus, the operator can adjust the nozzle touch force to a desired force and therefore, it becomes possible to prevent leakage of resin during injection due to an insufficient nozzle touch force or suppress defects of molded products generated because the nozzle touch force is too strong and the mold is deformed or an excessive force is applied to the mold.

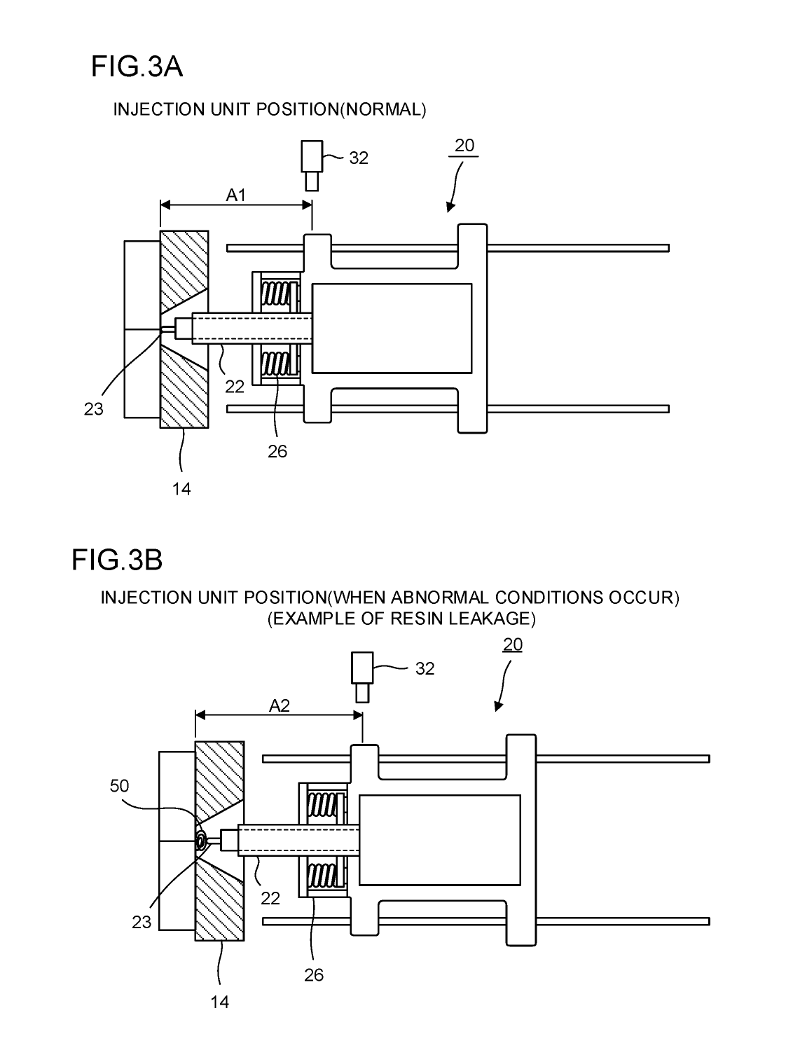

Next, an example when the position of the injection device 20 is calculated will be described. FIGS. 3A and 3B show a state in which the position of the injection device 20 is imaged by the video camera 32, FIG. 3A shows a state in which the injection device 20 is normal, and FIG. 3B shows a state in which abnormal conditions occur in the injection device 20. In FIGS. 3A and 3B, the depiction of the articulated robot 30 on which the video camera 32 is mounted and the like is omitted.

In FIGS. 3A and 3B, a marker or the like is attached to a portion of the injection device 20 and then the position of the video camera 32 is moved such that the marker is in the center of the imaging range from immediately above. Because the position of the articulated robot 30 on the fixed platen 14 on which the video camera is mounted is predetermined, the position of the injection device 20 can be calculated based on the mounting position of the articulated robot 30 and the position of the video camera 32 when imaging. The distance from the nozzle touch position under normal conditions in FIG. 3A is stored as A1. The articulated robot 30 can acquire positional information in each posture of the articulated robot 30 itself with respect to the injection molding machine and thus, the correct position of the injection unit in a shot image in any posture can be calculated.

The video camera 32 may not be arranged on the nozzle touch mechanism unit and thus, the amount of deformation of the elastic member and the position of the injection device 20 can be calculated accurately without the influence of vibration generated when the nozzle touch mechanism unit moves forward or backward or during nozzle touch.

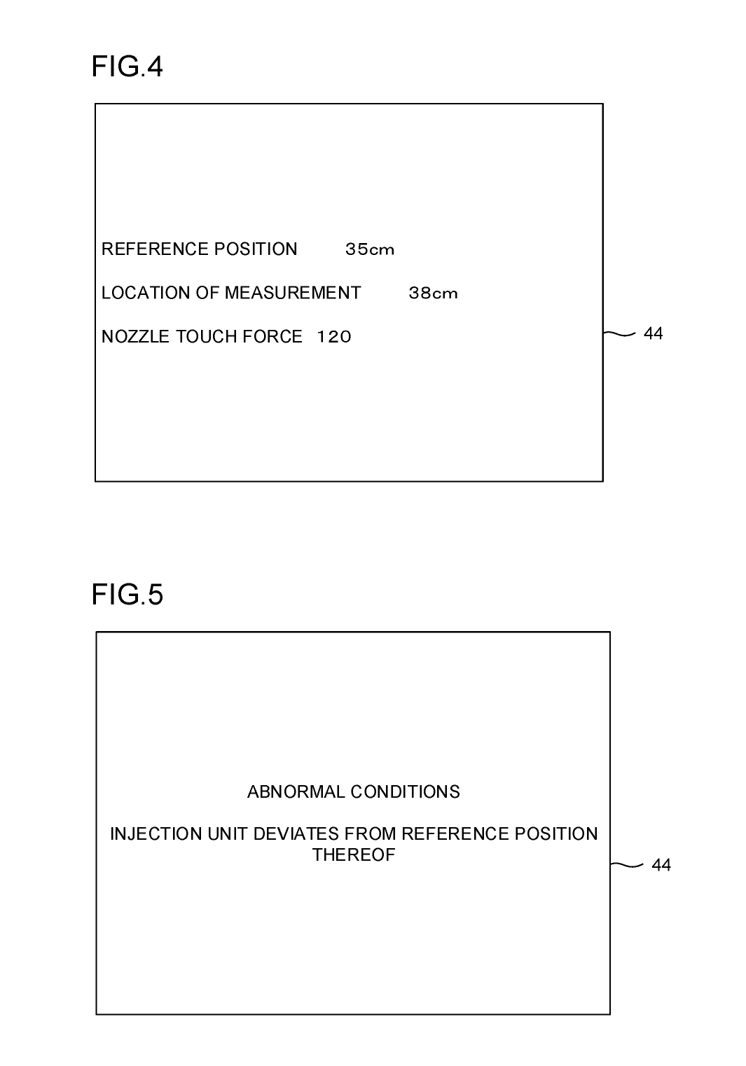

FIG. 3B shows a state when abnormal conditions occur in which a resin 50 where resin leakage occurs is present between the tip portion of the nozzle 23 and the fixed side mold 18. Like the case of FIG. 3A, the position of the injection device 20 is calculated by moving the position of the video camera 32 such that a marker is in the center of the imaging range from immediately above before imaging. In the case of FIG. 3B, the distance is A2, which is larger than A1, with the presence of the resin 50 where resin leakage occurs between the nozzle 23 and the fixed side mold 18. At this point, as shown in FIG. 4, the reference position of the injection unit, the position of the injection unit measured and calculated by an injection unit position calculation unit, and the nozzle touch force converted by a nozzle touch force conversion unit may be displayed in the display unit 44.

Whether a mold is deformed or a resin is leaked should automatically be detected, the position of the injection device 20 in a normal nozzle touch is stored in a storage unit as the injection unit reference position Al. Then, the position of the injection device 20 during actual measurement is measured and if the measurement result is equal to a predetermined amount or larger, a warning is issued by using the display unit 44, a warning lamp, an alarm sounding unit or the like. FIG. 5 is an example of the warning display in the display unit 44 and displays that abnormal conditions occur and the injection unit deviates from the reference position thereof.

In the present embodiment, the position and the amount of deformation of the elastic member 26 are shot and also the injection device 20 is shot for position measurement by the one video camera 32, but different video cameras may also be used for shooting the elastic member 26 and shooting the injection device 20. Also in the present embodiment, the articulated robot 30 is used as a movement unit for moving the video camera 32, but instead of the robot, a different mechanism can also be used. Further in the present embodiment, the articulated robot 30 is fixed onto the fixed platen 14, but may also be fixed to other places as long as the fixing position can be determined and used as the reference position for measurement.

1. An injection molding system including a mold, a nozzle capable of coming into contact with the mold, and an elastic member causing the nozzle to come into contact with the mold and having an injection unit causing the nozzle to generate a nozzle touch force by deforming the elastic member, the injection molding system comprising:
an elastic member shooting unit for shooting the elastic member;
a deformation amount calculation unit for calculating an amount of deformation of the elastic member from image data of the elastic member shot by the elastic member shooting unit; and
a nozzle touch force conversion unit for converting data of the amount of deformation calculated by the deformation amount calculation unit into the nozzle touch force based on a correlation between the amount of deformation of the elastic member and the nozzle touch force determined in advance.

2. The injection molding system according to claim 1, further comprising a nozzle touch force control unit capable of controlling by setting a predetermined nozzle touch force.

3. The injection molding system according to claim 1, further comprising an elastic member shooting position moving unit for moving a shooting position of the elastic member shooting unit.

4. The injection molding system according to claim 1, further comprising:
an injection unit shooting unit for shooting the injection unit; and
an injection unit position calculation unit for calculating a position of the injection unit based on image data of the injection unit shot by the injection unit shooting unit.

5. The injection molding system according to claim 4, further comprising:
an injection unit reference position storing unit for storing the position of the injection unit calculated by the injection unit position calculation unit in a normal nozzle touch as an injection unit reference position, wherein when the deformation amount calculation unit calculates a predetermined amount of deformation of the elastic member and a difference between the position of the injection unit calculated by the injection unit position calculation unit and the injection unit reference position exceeds the predetermined amount, a warning is issued.

6. The injection molding system according to claim 4, further comprising an injection unit shooting position moving unit for moving a shooting position of the injection unit shooting unit.

7. The injection molding system according to claim 6, wherein the position of the injection unit shooting unit is calculated based on position coordinates of the injection unit shooting position moving unit.

8. The injection molding system according to claim 4, wherein the injection unit shooting unit serves also as the elastic member shooting unit.

9. The injection molding system according to claim 5, further comprising a display unit capable of displaying the nozzle touch force converted by the nozzle touch force conversion unit, the position of the injection unit calculated by the injection unit position calculation unit, and the injection unit reference position.

10. The injection molding system according to claim 4, wherein the injection unit shooting position moving unit is a robot.

11. The injection molding system according to claim 4, wherein the injection unit shooting unit is arranged near a molded product extracting unit for extracting a molded product.
